(19) United States
(12) Patent Application Publication
(10) Pub. No.: US 2013/0020304 A1
(43) Pub. Date: Jan. 24, 2013

(54) ARTICLE OF CLOTHING HAVING AN ELECTRICALLY CONDUCTIVE ASSEMBLY

(71) Applicants: Erich Zainzinger, Taguig City (PH); Michael Benedict Corbett, Greensboro, NC (US); Huang Chen-Hsiang, Taipei (TW); Chen Wei, Yueyang City (CN); Haibo Fan, XinAn Town (CN)

(72) Inventors: Erich Zainzinger, Taguig City (PH); Michael Benedict Corbett, Greensboro, NC (US); Huang Chen-Hsiang, Taipei (TW); Chen Wei, Yueyang City (CN); Haibo Fan, XinAn Town (CN)

(21) Appl. No.: 13/549,999

(22) Filed: Jul. 16, 2012

Related U.S. Application Data
(60) Provisional application No. 61/508,836, filed on Jul. 18, 2011.

(51) Int. Cl. H05B 3/00

(52) U.S. Cl. 219/211; 219/212

(57) ABSTRACT

An article of clothing having an electrical assembly formed of conductive thread. The article includes a clothing article and an electrical assembly formed using conductive thread wherein the electrical assembly is adapted to form a part of the clothing article. A pliable connector may connect the electrical assembly to a power cord. The inventions may further include a power supply connected to the power cord.

### BACKGROUND OF THE INVENTIONS

(1) Field

The present inventions relate generally to apparel and, more particularly, to articles of clothing having an electrical assembly formed of conductive thread.

(2) Related Art Electrically heated clothing for motorcycle riding has been around since the 1970s. Electrically heated vests are popular because heating the torso affects the rider's entire body temperature and is less bulky than wearing layers of clothing. Many of the prior heated vests are formed of permanently fixed heating elements or removable heating elements.

One such example is U.S. Pat. No. 5,977,517 to Grosjean, issued Nov. 2, 1999, which is hereby incorporated by reference in its entirety. Grosjean discloses an electrically heated vest which is comprised of interchangeable designed modules including at least one heating element, a removable wiring harness, a machine washable shell, and a power cord with thermostat. The interchangeable modules are anatomically shaped and identically sized. The modules are fastened to the vest via snaps, buttons, VELCRO® (hook and loop fasteners) or equivalent. The wiring harness is removable from the vest and has quick disconnects for the modules and power cord. The vest is machine washable, has mating fasteners for the heating elements, and an inner liner and outer shell between which the modules are attached.

Generally conventional vests with permanently fixed heating elements must be hand washed and hence are not easily maintained. Other problems associated with prior heated vests include, for example, high voltage power sources, heavy weight, and lack of freedom of mobility. Heating element failure is also common and upon the failure of the heating elements, the wearer will suffer the discomfort of the cold climate and may be forced to terminate the outdoor activity. In addition, such clothing is generally limited only to providing resistive heating and is not adapted to provide other electrical functions,

Thus, there remains a need for new and improved articles of clothing which include an electrical assembly formed using conductive thread wherein the electrical assembly is adapted to form a part of the article of clothing while, at the same time, is durable and may be maintained without special treatment.

### SUMMARY OF THE INVENTIONS

The present inventions are directed to an article of clothing having an electrical assembly formed of conductive thread. The article of clothing includes a clothing article and an electrical assembly formed using conductive thread wherein the electrical assembly is adapted to form a part of the clothing article. A pliable connector may connect the electrical assembly to a power cord. The inventions may further include a power supply connected to the power cord.

The clothing article is selected from the group consisting of base layers, mid-layers, outer layers, and combinations thereof. The base layers may include underwear, long and short sleeve tops, full-length bottoms and briefs, sock liners and glove liners. The mid-layers may include shirts, hoodies, pants, lightweight jackets and gloves. The outer layers may include insulated jackets, insulated coats, pants, caps, insulated gloves and blankets, including surgical blankets.

In one embodiment, the electrical assembly includes an electrically nonconductive substrate and at least one electrically conductive pathway formed by attaching the conductive thread onto the nonconductive substrate.

The nonconductive substrate may be a woven substrate and the woven substrate may include plain, twill and satin woven fabrics. The substrate may be a knitted substrate and the knitted substrate may include weft knitted and warp knitted fabrics.

The nonconductive substrate also may be a nonwoven substrate and the nonwoven substrate may include fabrics formed by bonding fibers together by chemical, mechanical, heat and solvent treatment. For example, the substrate may be a film substrate and the film substrate may include nonporous, porous and microporous plastic films. Also, for example, the substrate may be a molded substrate and the molded substrate may include substrates formed by bonding fibers together by chemical, mechanical, heat and solvent treatment.

The electrically conductive pathway may be formed by sewing the conductive thread onto the nonconductive substrate. In one embodiment, the conductive thread is attached to the nonconductive substrate by a running stitch. Preferably, the stitched length of the running stitch is between about 1 mm and about 30 mm. More preferably, the stitched length of the running stitch is between about 10 mm and about 20 mm.

In one embodiment, the conductive thread is a multi-filament conductive thread. For example, the conductive thread may be a metallic thread. Preferably, the conductive thread is between about 200 denier and about 2500 denier. Also, preferably the conductive thread has a tensile strength between about 100 N/mm² and about 400 N/mm². In addition, preferably, the conductive thread has an electrical resistance between about ½ ohms per meter and about 10 ohms per meter.

In one embodiment, the electrical characteristics of the conductive thread are adapted for providing resistive heating. For example, the resistivity of the conductive thread may be about 4 ohms per meter and about 450 denier.

The electrical assembly may further include an electrically nonconductive diffusion layer attached to at least one surface of the electrical assembly. Preferably, the electrically nonconductive diffusion layer is thermally transparent.

The electrical assembly may also further include an electrically nonconductive mirror layer attached to at least one surface of the electrical assembly. Preferably, the electrically nonconductive mirror layer is thermally non-transparent

In one embodiment, the pliable connector includes stitching the ends of the conductive thread of the electrical assembly to the corresponding ends of the power cord. Preferably, the ends are stitched together with conductive thread.

The electrical assembly may further including a strain relief for the attachment of a power cord to the electrical assembly. Preferably, the strain relief is directly bonded to the electrical assembly. More preferably, the strain relief is stitched to the electrical assembly.

The electrical assembly may further include a control system for controlling the output of the power supply. In one embodiment, the power supply is a battery. Preferably, the battery is a rechargeable battery. In one embodiment, the control system is a switch. In another embodiment, the control system is a thermostat. The electrical assembly may further include a remote temperature sensor connected to the thermostat. In addition, the control system may further include a charging circuit.

Accordingly, one aspect of the present inventions is to provide an article of clothing having an electrical assembly formed of conductive thread, the article comprising: (a) a clothing article; and (b) an electrical assembly formed using conductive thread wherein the electrical assembly is adapted to form a part of the clothing article.

Another aspect of the present inventions is to provide in a clothing article, the improvement comprising: (a) an electrical assembly formed using conductive thread; and (b) a pliable connector connecting the electrical assembly to a power cord.

Still another aspect of the present inventions is to provide an article of clothing having an electrical assembly formed of conductive thread, the article comprising: (a) a clothing article; (b) an electrical assembly formed using conductive thread wherein the electrical assembly is adapted to form a part of the clothing article; (c) a pliable connector connecting the electrical assembly to a power cord; and (d) a power supply connected to the power cord.

These and other aspects of the present inventions will become apparent to those skilled in the art after a reading of the following description of the preferred embodiment when considered with the drawings.

### BRIEF DESCRIPTION OF THE DRAWINGS

FIG. 1 is a perspective view of a top garment article of clothing having an electrical assembly constructed according to the present inventions;

FIG. 2 is a perspective view of a bottom garment article of clothing also having an electrical assembly;

FIG. 3 is a front view of the electrical assembly;

FIG. 4 is a back view of the electrical assembly shown in FIG. 3;

FIG. 5A is a front view of the electrical assembly shown in FIG. 3 further including a diffusion layer attached to its front surface;

FIG. 5B is a back view of the electrical assembly shown in FIG. 3 further including a mirror layer attached to its back surface;

FIG. 6 is an exploded view of a control system attached to the electrical assembly;

FIG. 7 is a cross-sectional view of the electrical assembly shown in FIGS. 5A and 5B illustrating the respective locations of its various component layers;

FIG. 8 is an alternative embodiment of the electrical assembly shown in FIG. 3 illustrating the application of a welded tape over the connection with a power cord prior to completing the assembly;

FIG. 9 is another alternative embodiment of the electrical assembly shown in FIG. 3 illustrating a daisy chainable version also showing the application of a welded tape over one of the connections With a power cord (before the second welded tape is attached) prior to completing the assembly; and

FIGS. 10A-10F are schematic representations of additional embodiments of the present inventions shown in FIG. 1 illustrating various locations of the electrical assemblies and also daisy chained embodiments of the electrical assemblies.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

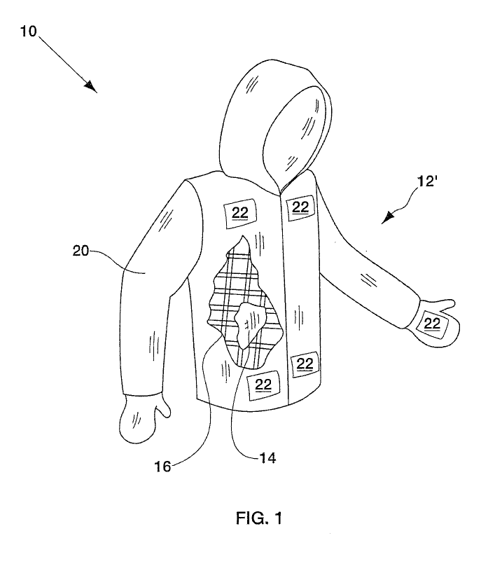

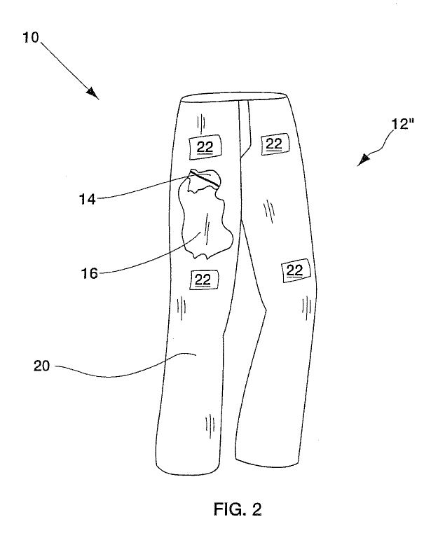

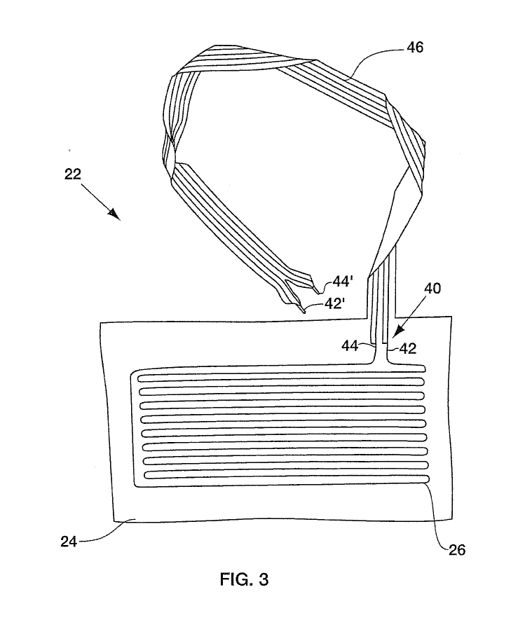

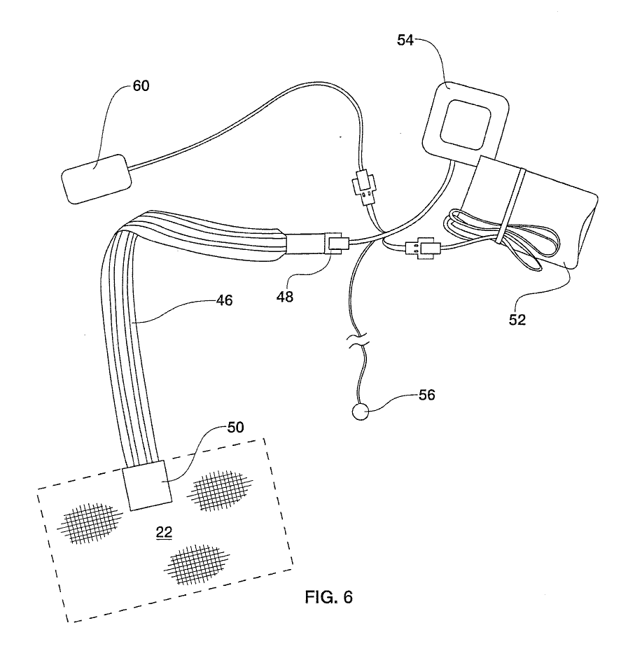

Referring now to the drawings in general and FIG. 1 in particular, it will be understood that the illustrations are for the purpose of describing preferred embodiments of the inventions and are not intended to limit the inventions thereto. As best seen in FIG. 1 for a top garment 12′ and FIG. 2 for a bottom garment 12″, an article of clothing, generally designated 10, having an electrical assembly 22 formed of conductive thread 26 is shown constructed according to the present inventions. The clothing article 10 includes an electrical assembly 22 formed using conductive thread 26 wherein the electrical assembly 22 is adapted to form a part of the clothing article 10. As best seen in FIG. 3, a pliable connector 40 may connect the electrical assembly 22 to a power cord 46. As best seen in FIG. 6, the inventions may further include a power supply 52 connected to the power cord 46.

The clothing article 10 is selected from the group consisting of base layers 14, mid-layers 16, outer layer 24, and combinations thereof. The base layers 14 may include underwear, long and short sleeve tops, full-length bottoms and briefs, sock liners and glove liners. The mid-layers 16 may include shirts, hoodies, pants, lightweight jackets and gloves. The outer layers 20 may include insulated jackets, insulated coats, pants, caps, insulated gloves and blankets, including surgical blankets.

Turning now to FIG. 3, in one embodiment, the electrical assembly 22 includes an electrically nonconductive substrate 24 and at least one electrically conductive pathway 28 formed by attaching the conductive thread 26 onto the nonconductive substrate 24.

The nonconductive substrate 24 may be a woven substrate and the woven substrate may include plain, twill and satin woven fabrics. The substrate 24 may be a knitted substrate and the knitted substrate may include well knitted and warp knitted fabrics. The nonconductive substrate 24 also may be a nonwoven substrate and the nonwoven substrate may include fabrics formed by bonding fibers together by chemical, mechanical, heat and solvent treatment. For example, the substrate 24 may be a film substrate and the film substrate may include nonporous, porous and microporous plastic films. Also, for example, the substrate 24 may be a molded substrate and the molded substrate may include substrates formed by bonding fibers together by chemical, mechanical, heat and solvent treatment.

The electrically conductive pathway 28 may be formed by sewing the conductive thread 26 onto the nonconductive substrate 24. In one embodiment, the conductive thread 26 is attached to the nonconductive substrate 24 by a running stitch.

As can be seen in FIG. 3, in one embodiment, the pliable connector 40 includes stitching the ends of the conductive thread 26 of the electrical assembly 22 to the corresponding ends 42, 44 of the power cord 46. Preferably, the ends are stitched together with conductive thread 26.

Preferably, the stitched length of the running stitch is between about 1 mm and about 30 mm. More preferably, the stitched length of the running stitch is between about 10 mm and about 20 mm.

The conductive thread 26 preferably is a multi-filament conductive thread. For example, the conductive thread 26 may be a metallic thread. Preferably, the conductive thread 26 is between about 200 denier and about 2500 denier. Also, preferably the conductive thread 26 has a tensile strength between about 100 N/mm² and about 400

N/mm². In addition, preferably, the conductive thread 26 has an electrical resistance between about ½ ohms per meter and about 10 ohms per meter.

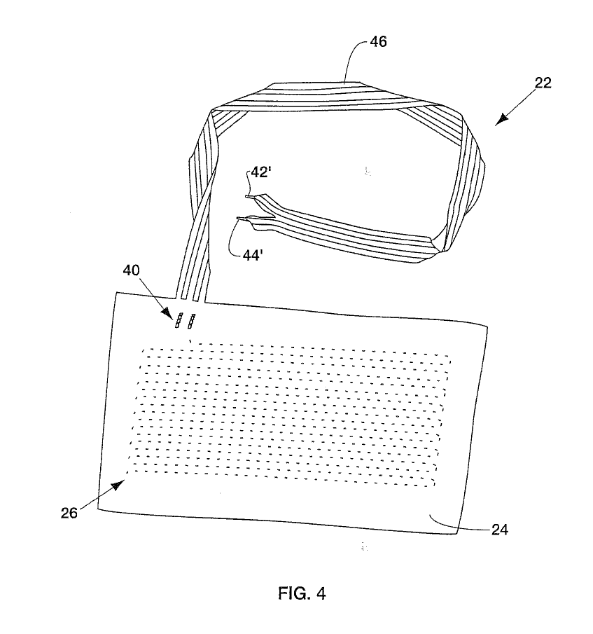

In one embodiment, the electrical characteristics of the conductive thread 26 are adapted for providing resistive heating. For example, the resistivity of the conductive thread 26 may be about 4 ohms per meter and about 450 denier. A back view of the stitching is best seen in FIG. 4.

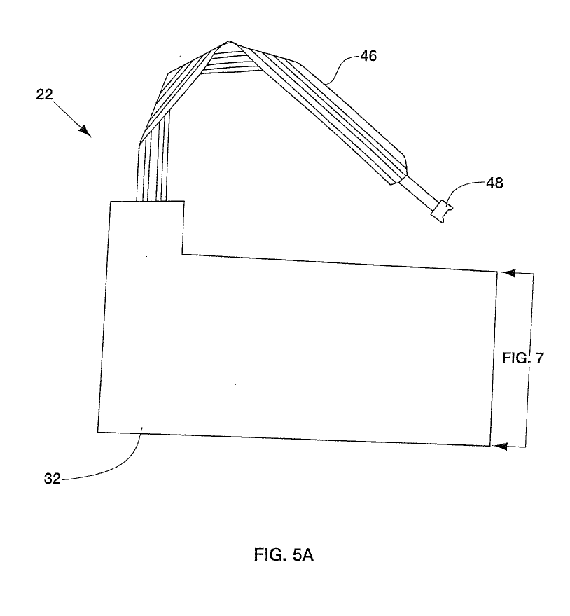

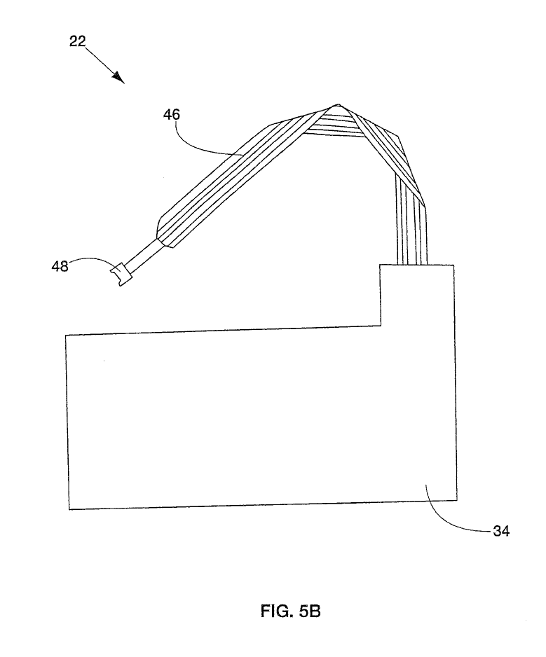

As best seen in FIG. 5A, the electrical assembly 22 may further include an electrically nonconductive diffusion layer 32 attached to at least one surface of the electrical assembly 22. Preferably, the electrically nonconductive diffusion layer 32 is a thermally transparent fabric, film, open mesh or similar material.

As best seen in FIG. 5B, the electrical assembly 22 may also further include an electrically nonconductive mirror layer 34 attached to at least one surface of the electrical assembly 22. Preferably, the electrically nonconductive mirror layer 34 is a thermally non-transparent fabric, reflective film or similar material.

As best seen in FIG. 6, the electrical assembly 22 may further including a strain relief 50 for the attachment of the power cord 46 to the electrical assembly 22. Preferably, the strain relief 50 is directly bonded to the electrical assembly 22. More preferably, the strain relief 50 is stitched to the electrical assembly 22.

The electrical assembly 22⁻may further include a control system 54 for controlling the output of the power supply 52. In one embodiment, the power supply 52 is a battery. Preferably, the battery is a rechargeable battery. In one embodiment, the control system 54 is a switch. In another embodiment, the control system 54 is a thermostat. The electrical assembly 22 may further include a remote temperature sensor 56 connected to the thermostat. In addition, the control system 54 may further include a conventional charging circuit 60.

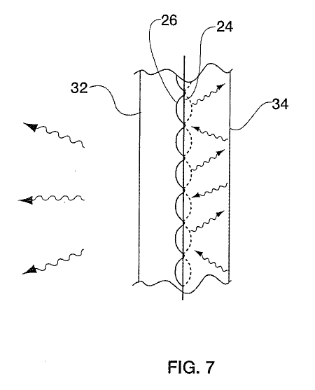

FIG. 7 is a cross-sectional view of the electrical assembly 22 shown in FIG. 5A illustrating the respective locations of the layers 32, 24 and 34. As can be seen in this embodiment, diffusion layer 32 allows heat from conductive thread 26 to pass through while, at the same time, limiting contact with other parts of the clothing article 10. On the opposite surface of substrate 24, mirror layer 34 reflects back heat from conductive thread 26 while, at the same time, also limiting contact with other parts of the clothing article 10. FIG. 7, along with previous FIGS. 3 and 4, also illustrate how the structure of the conductive pathway 28 formed by sewing the conductive thread 26 onto the nonconductive substrate 24 results controls the amount of conductive thread 26 on each side of substrate 24. For example, a balanced stitch would provide equal amounts of conductive thread 26 on each side of substrate 24. However, as can by comparing FIG. 3 to FIG. 4, by using a conventional thread on the bobbin with a spool of conductive thread 26, substantially all of the conductive thread 26 can be attached mostly to one surface of substrate 24 thereby improving the control of the direction of heat when that is desirable.

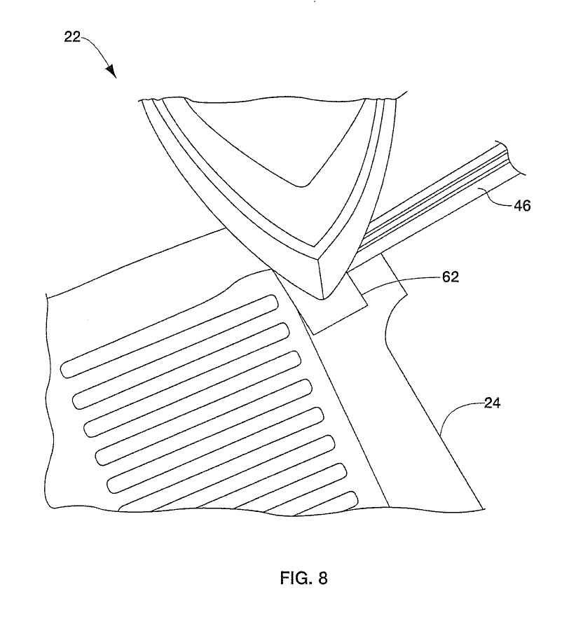

Turning now to FIG. 8, there is shown an alternative embodiment of the electrical assembly shown in FIG. 3 illustrating the application of a welded tape 62 over the connection 40 with power cord 46 prior to completing the assembly. Welded tape 62 may be applied before and in addition to strain relief 50 to aid in handling the electrical assembly 22 as its construction progresses. This provides increased stability and strength during the manufacturing process until the full assembly is completed.

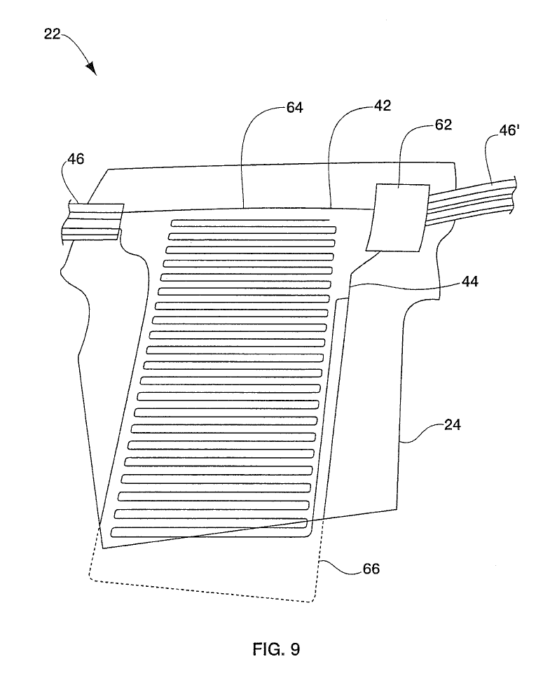

FIG. 9 is another alternative embodiment of the electrical assembly 22 shown in FIG. 3 illustrating a daisy chainable version of electrical assembly 22 and also showing the application of a welded tape 62 over one of the connections with power cord 46′ before the second welded tape is attached and prior to completing the assembly. As can be seen, conductors 64, 66 and ends 42, 22, respectively, of the conductive pathway 28 formed by conductive thread 26 form a circuit while, at the same time, extend and continue power cord 46 to power cord 46′ thereby allowing additional electrical assemblies 22′, 22″ to be daisy chained together.

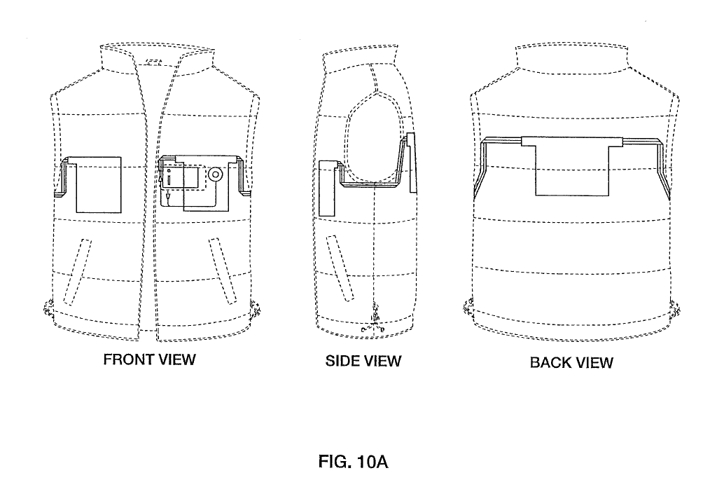

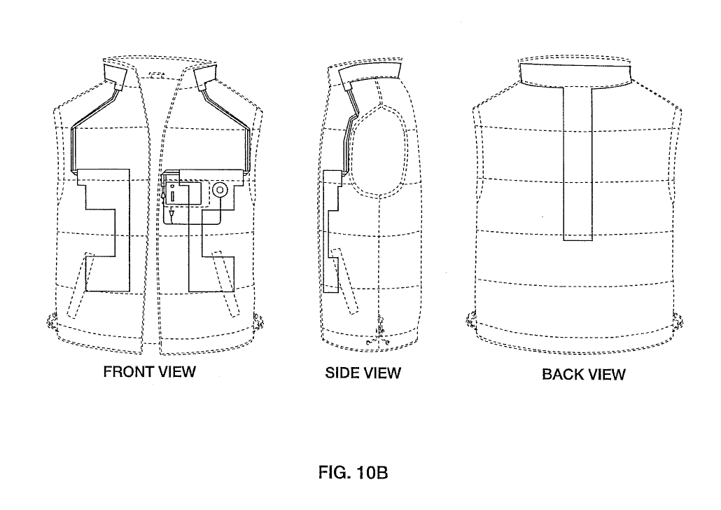

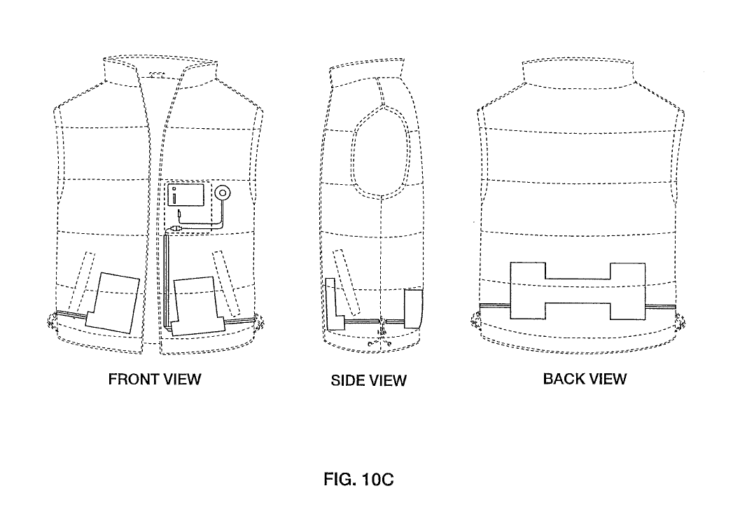

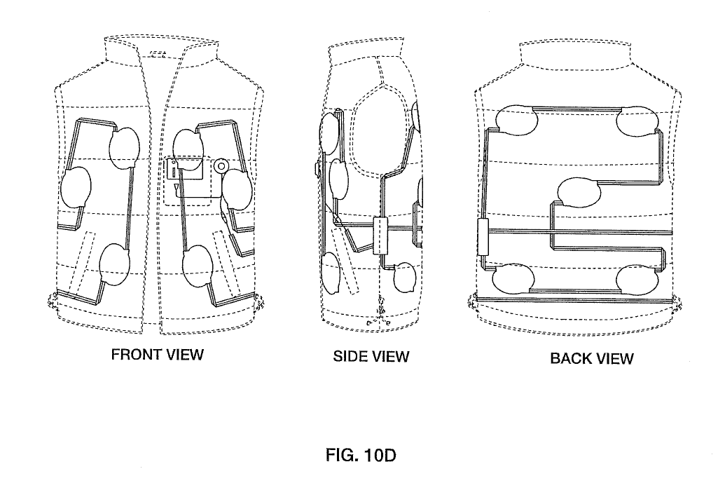

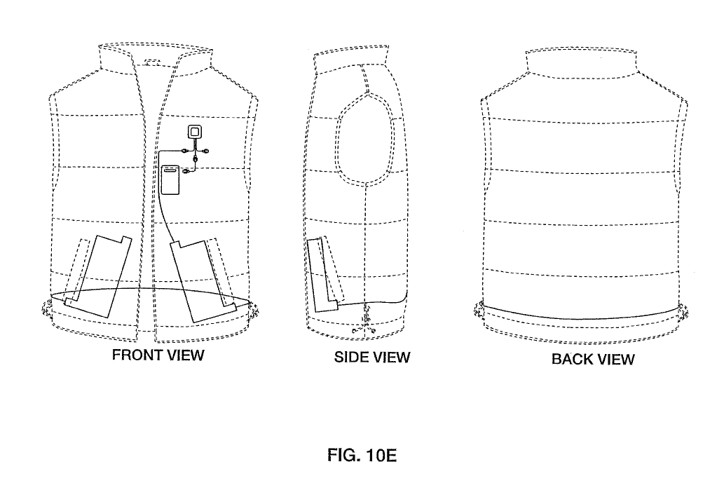

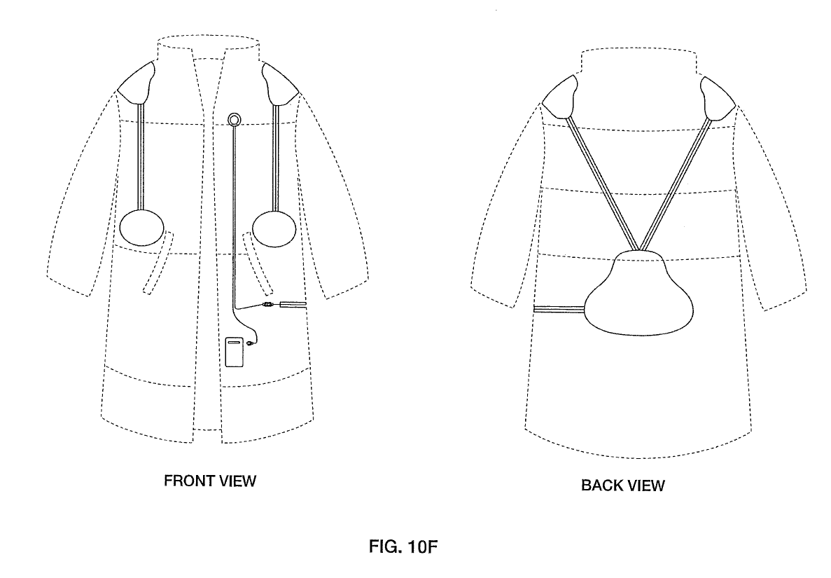

FIGS. 10A-10F are schematic representations of additional embodiments of the present inventions shown in FIG. 1 illustrating various locations of the electrical assemblies and additional daisy chained embodiments of the electrical assemblies.

In operation, one or more electrical assemblies 22 are attached into an article of clothing 10 in various locations where heat or electrical power or both are desired. The article of clothing 10 is completed in a conventional way with connector 48 accessible to allow the wearer to connect the power cord 46 to power supply 52 and control system 54 as needed or disconnected when not in use or for cleaning the clothing.

Certain modifications and improvements will occur to those skilled in the art upon a reading of the foregoing description. By way of example, integration of both electrical signal and power lines using electrically conductive thread with different electrical resistance values into fabrics to form an electrical system adapted to one or more electrical components as well as a resistive heating conductive pathway by stitching or embroidery processes. Also, the resistive heating conductive pathway may be connected to a power source which may include control electronic for selectable heating output and may include a temperature sensor for automatic heat adjustments or overheating protection. Also, electrical connections may be made between the electrically conductive pathways by printing onto them with electrically conductive ink and other electrical components such as cables by sewing with electrically conductive yarn across the conductive pathway and the electrical connection points such as cable terminations to farm an electrically functioning connect between the electrically conductive pathways and cable contact points. It should be understood that all such modifications and improvements have been deleted herein for the sake of conciseness and readability but are properly within the scope of the following claims.

25

We claim:

1. An article of clothing having an electrical assembly formed of conductive thread, said article comprising:
(a) a clothing article; and
(b) an electrical assembly formed using conductive thread wherein said electrical assembly is adapted to form a part of said clothing article.

2. The article according to claim 1 further including a power supply connected to said electrical assembly.

3. The article according to claim 2, wherein said power supply is a battery.

4. The article according to claim 3, wherein said battery is a rechargeable battery.

5. The article according to claim 2 further including a control system for controlling the output of said power supply.

6. The article according to claim 5, wherein said control system is a switch.

7. The article according to claim 5, wherein said control system is a thermostat.

8. The article according to claim 7 further including a remote temperature sensor connected to said thermostat.

9. The article according to claim 5, wherein said control system further includes a charging circuit.

10. The article according to claim 1, wherein said clothing article is selected from the group consisting of base layers, mid-layers, outer layers, and combinations thereof.

11. The article according to claim 10, wherein said base layers include underwear, long and short sleeve tops, full-length bottoms and briefs, sock liners and glove liners.

12. The article according to claim 10, wherein said mid-layers include shirts, hoodies, pants, lightweight jackets and gloves.

13. The article according to claim 10, wherein said outer layers include insulated jackets, insulated coats, pants, caps, insulated gloves and blankets, including surgical blankets.

14. In a clothing article, the improvement comprising:
(a) an electrical assembly formed using conductive thread; and
(b) a pliable connector connecting said electrical assembly to a power cord.

15. The article according to claim 14, wherein said electrical assembly includes an electrically nonconductive substrate and at least one electrically conductive pathway formed by attaching the conductive thread onto said nonconductive substrate.

16. The article according to claim 15, wherein said substrate is a woven substrate.

17. The article according to claim 16, wherein said woven substrate includes plain, twill and satin woven fabrics.

18. The article according to claim 15, wherein said substrate is a knitted substrate.

19. The article according to claim 18, wherein said knitted substrate includes weft knitted and warp knitted fabrics.

20. The article according to claim 15, wherein said substrate is a nonwoven substrate.

21. The article according to claim 20, wherein said nonwoven substrate includes fabrics formed by bonding fibers together by chemical, mechanical, heat and solvent treatment.

22. The article according to claim 15, wherein said substrate is a film substrate.

23. The article according to claim 22, wherein said film substrate includes nonporous, porous and microporous plastic films.

24. The article according to claim 15, wherein said substrate is a molded substrate.

25. The article according to claim 24, wherein said molded substrate includes substrates formed by bonding fibers together by chemical, mechanical, heat and solvent treatment.

26. The article according to claim 15, wherein said at least one electrically conductive pathway is formed by sewing the conductive thread onto said nonconductive substrate.

27. The article according to claim 26, wherein the conductive thread is attached to said nonconductive substrate by a running stitch.

28. The article according to claim 27, wherein the stitched length of said running stitch is between about 1 mm and about 30 mm.

29. The article according to claim 28, wherein the stitched length of said running stitch is between about 10 mm and about 20 mm.

30. The article according to claim 15, wherein said conductive thread is a multi-filament conductive thread.

31. The article according to claim 30, wherein said conductive thread is a metallic thread.

32. The article according to claim 31, wherein said conductive thread is between about 200 denier and about 2500 denier.

33. The article according to claim 31, wherein said conductive thread has a tensile strength between about 100 N/mm² and about 400 N/mm².

34. The article according to claim 31, wherein said conductive thread has an electrical resistance between about ½ ohms per meter and about 10 ohms per meter.

35. The article according to claim 31, wherein the electrical characteristics of said conductive thread are adapted for providing resistive heating.

36. The article according to claim 35, wherein the resistivity of said conductive thread is about 4 ohms per meter and about 450 denier.

37. The article according to claim 14, further including an electrically nonconductive diffusion layer attached to at least one surface of said electrical assembly.

38. The article according to claim 37, wherein said electrically nonconductive diffusion layer is thermally transparent.

39. The article according to claim 14, further including an electrically nonconductive mirror layer attached to at least one surface of said electrical assembly.

40. The article according to claim 39, wherein said electrically nonconductive mirror layer is thermally non-transparent.

41. The article according to claim 14, wherein the pliable connector includes stitching the ends of the conductive thread of said electrical assembly to the corresponding ends of said power cord.

42. The article according to claim 41, wherein the ends are stitched together with conductive thread.

43. The article according to claim 14, further including a strain relief for the attachment of a power cord to said electrical assembly,

44. The article according to claim 43, wherein said strain relief is directly bonded to said electrical assembly.

45. The article according to claim 44, wherein said strain relief is stitched to said electrical assembly.

46. An article of clothing having an electrical assembly formed of conductive thread, said article comprising:
(a) a clothing article;
(b) an electrical assembly formed using conductive thread wherein said electrical assembly is adapted to form a part of said clothing article;
(c) a pliable connector connecting said electrical assembly to a power cord; and
(d) a power supply connected to said power cord.

47. The article according to claim 46, wherein said power supply is a battery.

48. The article according to claim 47, wherein said battery is a rechargeable battery.

49. The article according to claim 46 further including a control system for controlling the output of said power supply.

50. The article according to claim 49, wherein said control system is a switch.

51. The article according to claim 49, wherein said control system is a thermostat.

52. The article according to claim 51 further including a remote temperature sensor connected to said thermostat.

53. The article according to claim 59, wherein said control system further includes a charging circuit.

54. The article according to claim 46, wherein said clothing article is selected from the group consisting of base layers, mid-layers, outer layers, and combinations thereof.

55. The article according to claim 54, wherein said base layers include underwear, long and short sleeve tops, full-length bottoms and briefs, sock liners and glove liners.

56. The article according to claim 54, wherein said mid-layers include shirts, hoodies, pants, lightweight jackets and gloves.

57. The article according to claim 54, wherein said outer layers include insulated jackets, insulated coats, pants, caps, insulated gloves and blankets, including surgical blankets.

58. The article according to claim 46, wherein said electrical assembly includes an electrically nonconductive substrate and at least one electrically conductive pathway formed by attaching the conductive thread onto said nonconductive substrate.

59. The article according to claim 58, wherein said substrate is a woven substrate.

60. The article according to claim 59, wherein said woven substrate includes plain, twill and satin woven fabrics.

61. The article according to claim 58, wherein said substrate is a knitted substrate.

62. The article according to claim 61, wherein said knitted substrate includes weft knitted and warp knitted fabrics.

63. The article according to claim 58, wherein said substrate is a nonwoven substrate.

64. The article according to claim 63, wherein said nonwoven substrate includes fabrics formed by bonding fibers together by chemical, mechanical, heat and solvent treatment.

65. The article according to claim 58, wherein said substrate is a film substrate.

66. The article according to claim 65, wherein said film substrate includes nonporous, porous and microporous plastic films.

67. The article according to claim 58, wherein said substrate is a molded substrate.

68. The article according to claim 67, wherein said molded substrate includes substrates formed by bonding fibers together by chemical, mechanical, heat and solvent treatment.

69. The article according to claim 58, wherein said at least one electrically conductive pathway is formed by sewing the conductive thread onto said nonconductive substrate.

70. The article according to claim 69, wherein the conductive thread is attached to said nonconductive substrate by a running stitch.

71. The article according to claim 70, wherein the stitched length of said running stitch is between about 1 mm and about 30 mm.

72. The article according to claim 71, wherein the stitched length of said running stitch is between about 10 mm and about 20 mm.

73. The article according to claim 58, wherein said conductive thread is a multi-filament conductive thread.

74. The article according to claim 73, wherein said conductive thread is a metallic thread.

75. The article according to claim 74, wherein said conductive thread is between about 200 denier and about 2500 denier.

76. The article according to claim 74, wherein said conductive thread has a tensile strength between about 100 N/mm² and about 400 N/mm².

77. The article according to claim 74, wherein said conductive thread has an electrical resistance between about ½ ohms per meter and about 10 ohms per meter.

78. The article according to claim 74, wherein the electrical characteristics of said conductive thread are adapted for providing resistive heating.

79. The article according to claim 78, wherein the resistivity of said conductive thread is about 4 ohms per meter and about 450 denier.

80. The article according to claim 46, further including an electrically nonconductive diffusion layer attached to at least one surface of said electrical assembly.

81. The article according to claim 80, wherein said electrically nonconductive diffusion layer is thermally transparent.

82. The article according to claim 46, further including an electrically nonconductive mirror layer attached to at least one surface of said electrical assembly.

83. The article according to claim 82, wherein said electrically nonconductive mirror layer is thermally non-transparent.

84. The article according to claim 46, wherein the pliable connector includes stitching the ends of the conductive thread of said electrical assembly to the corresponding ends of said power cord.

85. The article according to claim 84, wherein the ends are stitched together with conductive thread.

86. The article according to claim 46, further including a strain relief for the attachment of a power cord to said electrical assembly.

87. The article according to claim 86, wherein said strain relief is directly bonded to said electrical assembly.

88. The article according to claim 87, wherein said strain relief is stitched to said electrical assembly.
